(19) United States
(12) Patent Application Publication
(10) Pub. No.: US 2024/0262432 A1
(43) Pub. Date: Aug. 8, 2024

(54) TAILGATE SECURITY BRACKET ASSEMBLIES AND METHODS OF MAKING AND USING THE SAME

(71) Applicant: Charles Cochran, St. Marys, GA (US)

(72) Inventor: Charles Cochran, St. Marys, GA (US)

(21) Appl. No.: 18/434,365

(22) Filed: Feb. 6, 2024

Related U.S. Application Data
(60) Provisional application No. 63/443,632, filed on Feb. 6, 2023.

(51) Int. Cl. B62D 33/037

(52) U.S. Cl. CPC B62D 33/037

(57) ABSTRACT

The present invention discloses tailgate security bracket assemblies and methods of making and using the same. The tailgate security bracket assembly comprises a retainment plate positioned in a first plane, a lateral plate having a first connection edge and a second connection edge, a longitudinal attachment plate having a forward edge and a back edge and one or more fastener assemblies to attach the tailgate security bracket assembly onto the vehicle. The lateral plate is connected to the retainment plate at the first connection edge, and the lateral plate extends inboard from the retainment plate. The back edge of the longitudinal attachment plate is connected to the lateral plate at the second connection edge. The longitudinal attachment plate is positioned in a second plane. The second plane is parallel to, and spaced inboard from, the first plane. Further, at least one fastener assembly is disposed at the longitudinal attachment plate.

### RELATED APPLICATION

This application claims priority to U.S. Provisional Application 63/443,632 filed on Feb. 6, 2023, entitled “Tailgate Security Bracket Assemblies and Methods of Making and Using the Same”, the entirety of which is incorporated herein.

### TECHNICAL FIELD

The present invention relates generally to the tailgate of a vehicle. More specifically, the present invention relates to a tailgate security bracket assembly for mounting on a vehicle bed or sidewall of a truck bed, of a vehicle such as a pickup truck, to secure a tailgate of the vehicle and to prevent theft of the tailgate.

### BACKGROUND

A tailgate is a well-known and highly useful component of a wide variety of vehicles. In particular, a tailgate is a known component of a pick-up truck, i.e., a pickup. A pickup is a highly useful vehicle that can be used to haul a wide variety of items. A pickup commonly includes a cab and a cargo bed. The cargo bed can be described as simply a “bed.”

The cargo bed can include, in known manner, a front panel, a pair of side panels that extend on opposing sides of the bed, a tailgate, and a bottom. The bottom, front panel, side panels, and tailgate provide an open box or cargo space that can be used to carry items such as tools, appliances, building materials, granular material such as sawdust or sand, and innumerable other items. The bed of a pickup can be provided with a liner or mat on the bottom of the bed. Such liner or mat can protect the bottom of the cargo bed from moisture and from physical damage as items are loaded into and unloaded from the cargo bed. The bottom of the bed can be constructed of corrugated steel, for example.

In a known manner, the tailgate of a pickup can be rotated from a closed position to an open position. In the closed position, the tailgate can be latched so as to be secured in the closed position. In the closed position, the tailgate is typically vertically oriented so as to close the cargo bed. A user can manipulate a latch so as to open the tailgate. If the vehicle is locked, a user may be precluded from manipulating the latch so as to open the tailgate. Once unlatched, the tailgate can then be lowered, i.e., pivoted to an open position. In the open position, the tailgate is typically in a horizontal position, and supported by support straps or linkages on sides of the tailgate. The opened tailgate can provide a useful working surface, which extends off the back of the pickup.

The tailgate can include a body and opposing pins that extend outwardly from opposing, lower corners of the body of the tailgate. Each pin can be received into respective pin sockets in respective side panels of the bed of the pickup. That is, each side panel can include a rear corner structure. The rear corner structure, of a side panel, can provide a reinforced structure at the rear of the bed of the pickup. The rear corner structure can be in the form of or include a column. The rear corner structure can provide reinforcement to withstand physical damage in the loading and unloading of the pickup. The rear corner structure can also serve to house the pin socket that serves to pivotally support the tailgate. That is, the rear corner structure (of each of the side panels, on each side of the truck) can serve to pivotally support the tailgate. Accordingly, the tailgate can be rotated from a closed position to the open position. In the open position, in which the tailgate can be substantially horizontal, the tailgate can typically be maintained and supported by both the pins of the tailgate as well as retainer straps or support straps on each side. In known manner, a respective support strap can be provided on both sides of the bed. A support strap can extend between a connection point on an upper portion of the rear corner structure (of a side panel of the bed) and an outer connection point on the side of the tailgate. In lieu of support straps on each side, to support the tailgate in the open position, metal linkages can be used—as was more common in older tailgates.

A side panel, of a bed of a pickup, can be constructed so as to be of uniform thickness along the inner side of each side panel. Alternatively, a side panel of a pickup can be constructed so as to be more open on an interior side of the side panel. With such construct, in each side panel, there may be provided a rear corner structure, center column structure and a front corner structure, for example, that are all visible from an interior of the bed. Sheet metal or other material can be provided on an outboard side of the rear corner structure, center column structure and front corner structure so as to form the outer skin of the pickup. Accordingly, an open space or pocket can be provided, on the interior (or inboard side) of each side panel between the rear corner structure and the center column structure. Such pocket can be described as a rear side panel pocket. In general, the side panel of a pickup can be constructed of various support structure, column structure, open spaces and/or closed spaces. The particular construct of a bed of a pickup or other vehicle can vary widely between different makes and models of vehicles.

A tailgate of a pickup can be removed by a user of the vehicle. The particular methodology to remove the tailgate from a pickup, for example, can vary between different vehicles. In accord with one, known methodology, a first step to remove the tailgate can include disconnecting wiring of the tailgate. That is, the tailgate can be provided with a variety of electrical features. The tailgate can be provided with various electrical components including a camera, a lock for the latch of the tailgate and various lights, for example. Such electrical components can be connected via tailgate wiring to a tailgate harness or plug. The tailgate harness can be plugged into or otherwise mated with a vehicle harness so as to provide electrical connection between the tailgate and the vehicle.

The tailgate harness, which is plugged into the vehicle harness, can typically be accessed underneath the bed of the vehicle and tucked into or forward of the rear bumper of the vehicle. Accordingly, so as to electrically disconnect the tailgate from the vehicle, the tailgate harness can be disconnected from, e.g., pulled out of, the vehicle harness. Disconnection of the harnesses may require depression or manipulation of a locking tab or some other mechanism.

Once the electrical wiring of the tailgate is disconnected from the remainder of the vehicle, a next step in removing the tailgate can include unlatching the tailgate and lowering the tailgate halfway, i.e., at a 45-degree angle. Then, for some pickups, removal of the tailgate can include sliding the passenger-side (i.e., right-side) pin of the tailgate out of the right socket of the side panel. Further, with some tailgates, the right pin may be of a “flattened” geometry, rather than being round. Accordingly, it may be needed to align the flattened pin with a notch in the socket, e.g., when the tailgate is at a 45 degree angle from vertical. With such arrangement, the right side of the tailgate may then be pulled (back and up) in conjunction with the pin sliding out of the slot of the socket. Once the right side of the tailgate is free, the tailgate can be physically slid to the right, so as to remove the left pin of the tailgate from the left socket (in the left side panel). With the tailgate physically free from the side panels and the tailgate electrically disconnected, removal of the tailgate from the pickup is complete.

Accordingly, various aspects of construct of a tailgate, of a pickup or other vehicle, and removal of a tailgate have been described above.

It is appreciated that a tailgate of a modern-day pickup can be a “high dollar item.” The high cost of a tailgate can be attributed to various technology and structural engineering that is integrated into the physical structure of the tailgate. The high cost of a tailgate can also be attributed to the various electronics, such as expensive camera and light components, that are integrated into the modern-day pickup truck.

Given that a tailgate can be a “high dollar item,” a tailgate can become a target for thieves. An experienced thief can remove and steal a tailgate in a matter of minutes if not seconds. Even if the vehicle is locked, an experienced thief may find a way to unlock or short-circuit the lock in the tailgate, so that the latch of the tailgate can be opened. Current technology fails to adequately secure a tailgate and fails to adequately provide anti-theft devices so as to prevent theft of a tailgate.

The embodiments of the disclosure address these and other deficiencies in known technology.

### SUMMARY OF THE INVENTION

The present invention discloses tailgate security bracket assemblies and methods of making and using the same. The tailgate security bracket assembly comprises a retainment plate positioned in a first plane, a lateral plate having a first connection edge and a second connection edge, a longitudinal attachment plate having a forward edge and a back edge and one or more fastener assemblies to attach the tailgate security bracket assembly onto the vehicle. The lateral plate is connected to the retainment plate at the first connection edge, and the lateral plate extends inboard from the retainment plate. The back edge of the longitudinal attachment plate is connected to the lateral plate at the second connection edge. The longitudinal attachment plate is positioned in a second plane. The second plane is parallel to, and spaced inboard from, the first plane. The lateral plate is substantially at a 90-degree angle to the first plane and the second plane, so as to space the first plane from the second plane.

The retainment plate comprises a securement slot. The securement slot is configured to receive a support pin of the tailgate. In one embodiment, the securement slot is a curved edge segment. The tailgate security bracket assembly further comprises a retainment flange disposed at the retainment plate. The retainment flange extends at least one of inboard and outboard from the securement slot. The retainment flange is provided to reinforce the securement slot.

In one embodiment, the retainment plate, the lateral plate and the longitudinal attachment plate integrally formed from sheet metal. The first connection edge including a first bend in the sheet metal, and the second connection edge including a second bend in the sheet metal.

In another embodiment, the bracket assembly further comprises a transverse attachment plate connected to the forward edge of longitudinal attachment plate. The transverse attachment plate extends parallel to the lateral plate. The transverse attachment plate is provided to engage with the vehicle, so as to secure the tailgate security bracket onto the vehicle. The transverse attachment plate is connected to the longitudinal attachment plate such that the transverse attachment plate is oriented at 90 degree angle to the longitudinal attachment plate, and configured to engage a rear post of the vehicle bed, of the vehicle.

In yet another embodiment, the lateral plate further comprises a lateral extension extending outboard from the first connection edge and lies in line with the lateral plate.

In yet another embodiment, the bracket assembly comprises a first bracket and a second bracket. A top portion of the lateral plate, the longitudinal attachment plate and the transverse attachment plate together forms a substantially U-shaped configuration defining the first bracket, and a bottom portion of the lateral plate, the longitudinal attachment plate and the transverse attachment plate together forms a substantially U-shaped configuration defining the second bracket. The first bracket is fastened to the second bracket to form a single u-shaped configuration.

Further, at least one fastener assembly is disposed at the longitudinal attachment plate. In one embodiment, the fastener assembly comprises a bolt and a nut. The longitudinal attachment plate includes a hole. Thee bolt extends through the hole of the longitudinal attachment plate to attach to a rear structure of the vehicle bed. Further, the nut is threaded onto the bolt. In another embodiment, the bracket assembly comprises a plurality of fasteners that are configured to attach the longitudinal attachment plate to the vehicle bed.

In another embodiment, the fastener assembly comprises a stud fastened onto the longitudinal attachment plate so as to extend outboard from a surface of the longitudinal attachment plate. The stud is configured to provide attachment to a rear structure of the vehicle bed. The fastener assembly comprises a nut threaded onto the stud. The fastener assembly is configured so as to sandwich the rear structure of the vehicle bed, between the longitudinal attachment plate and the nut.

In one embodiment, the retainment plate, lateral plate, longitudinal attachment plate and transverse attachment plate forming a bracket, of the tailgate security bracket assembly, is integrally formed from an originally flat piece of sheet metal that is bent into shape of the bracket. In another embodiment, the retainment plate, the lateral plate, the longitudinal attachment plate and the transverse attachment plate forming a bracket, is cast into shape of the bracket.

The above summary contains simplifications, generalizations and omissions of detail and is not intended as a comprehensive description of the claimed subject matter but, rather, is intended to provide a brief overview of some of the functionality associated therewith. Other systems, methods, functionality, features and advantages of the claimed subject matter will be or will become apparent to one with skill in the art upon examination of the following figures and detailed written description.

### BRIEF DESCRIPTION OF THE DRAWINGS

The description of the illustrative embodiments can be read in conjunction with the accompanying figures. It will be appreciated that for simplicity and clarity of illustration, elements illustrated in the figures have not necessarily been drawn to scale. For example, the dimensions of some of the elements are exaggerated relative to other elements. Embodiments incorporating teachings of the present disclosure are shown and described with respect to the figures presented herein, in which:

FIG. 1 is a side perspective view showing a tailgate security bracket assembly of a first embodiment, in accordance with principles of the disclosure.

FIG. 2 is a further side perspective view showing the tailgate security bracket assembly of FIG. 1, in accordance with principles of the disclosure.

FIG. 3 is a side perspective view showing a tailgate security bracket assembly of a second embodiment, in accordance with principles of the disclosure.

FIG. 4 is a bottom perspective view showing the tailgate security bracket assembly of FIG. 3, in accordance with principles of the disclosure.

FIG. 5 is a further bottom perspective view showing the tailgate security bracket assembly of FIG. 3, in accordance with principles of the disclosure.

FIG. 6 is a back perspective view showing the tailgate security bracket assembly of FIG. 3, in accordance with principles of the disclosure.

FIG. 7 is a bottom perspective view showing the tailgate security bracket assembly of FIG. 3, in accordance with principles of the disclosure.

FIG. 8A is a top view schematic diagram showing a bracket the same as or similar to the bracket shown in FIG. 1, in accordance with principles of the disclosure.

FIG. 8B is a further schematic diagram showing a bracket with more rounded corners as compared to the bracket shown in FIG. 9, in accordance with principles of the disclosure.

FIG. 9 is a flowchart showing a tailgate security bracket assembly install process of an embodiment, in accordance with principles of the disclosure.

FIG. 10 is a side perspective view showing a tailgate security bracket assembly of a third embodiment installed on a vehicle, in accordance with principles of the disclosure.

FIG. 11 is a top perspective view showing the tailgate security bracket assembly of FIG. 10 installed on a vehicle, in accordance with principles of the disclosure.

FIG. 12 is a top back perspective view showing the tailgate security bracket assembly of FIG. 10 installed on a vehicle, in accordance with principles of the disclosure.

FIG. 13 is a back perspective view showing the tailgate security bracket assembly of FIG. 10 installed on a vehicle, in accordance with principles of the disclosure.

FIG. 14 is a further back perspective view showing the tailgate security bracket assembly of FIG. 10 installed on a vehicle, in accordance with principles of the disclosure.

FIG. 15 is a side perspective view showing a fastener mechanism (of the tailgate security bracket assembly of FIG. 10) that extends into the tail light socket, in accordance with principles of the disclosure.

FIG. 16 is a side view of a tailgate security bracket assembly of yet another embodiment, in accordance with principles of the disclosure.

### DETAILED DESCRIPTION OF EXAMPLE EMBODIMENTS

Hereinafter, aspects of the disclosure in accordance with various embodiments will be described. As used herein absent context to the contrary, any term in the singular may be interpreted to be in the plural, and alternatively, any term in the plural may be interpreted to be in the singular.

The present invention discloses tailgate security bracket assemblies and methods of making and using the same. More specifically, the disclosure provides a tailgate security bracket assembly, i.e. a bracket assembly, that can assist in preventing the removal and theft of a tailgate from a vehicle. In particular, the tailgate security bracket assembly of the disclosure can provide an anti-theft device or security device to prevent the tailgate of a pickup truck from being stolen. In an embodiment, the bracket assembly can include a retainment flange. The retainment flange can enclose and/or surround a tailgate pin of the tailgate of a pickup truck. Relatedly, as described above, removal of a tailgate commonly includes a side (commonly the right side) of the tailgate being pulled backwards and upwards, away from the bed of the pickup. Such movement can be performed so as to slide the tailgate pin (of the tailgate) out of the socket in which the tailgate pin is housed. However, the tailgate security bracket assembly of the disclosure prevents such removal of the tailgate pin from its socket. Accordingly, the tailgate security bracket assembly of the disclosure prevents theft of the tailgate. Further, in some tailgate arrangements, the socket (that houses the tailgate pin) can be secured with fasteners, such as screws. However, with the tailgate security bracket assembly of the disclosure, even if such fasteners are removed, the tailgate security bracket assembly can still secure the tailgate in place and prevent theft. Many additional features of the tailgate security bracket assembly are described in detail below.

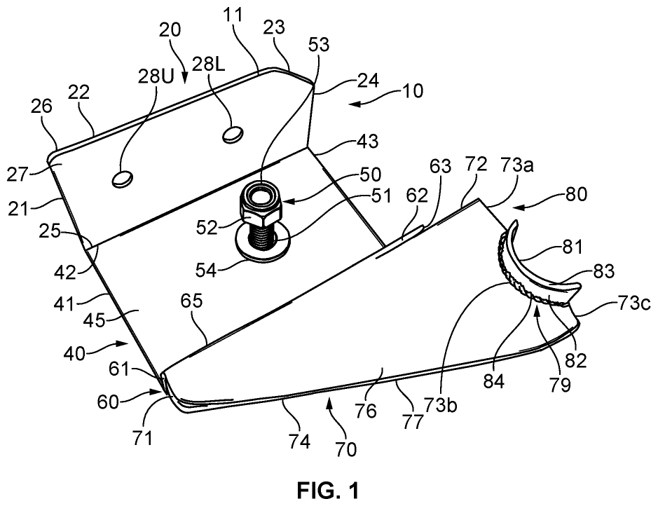

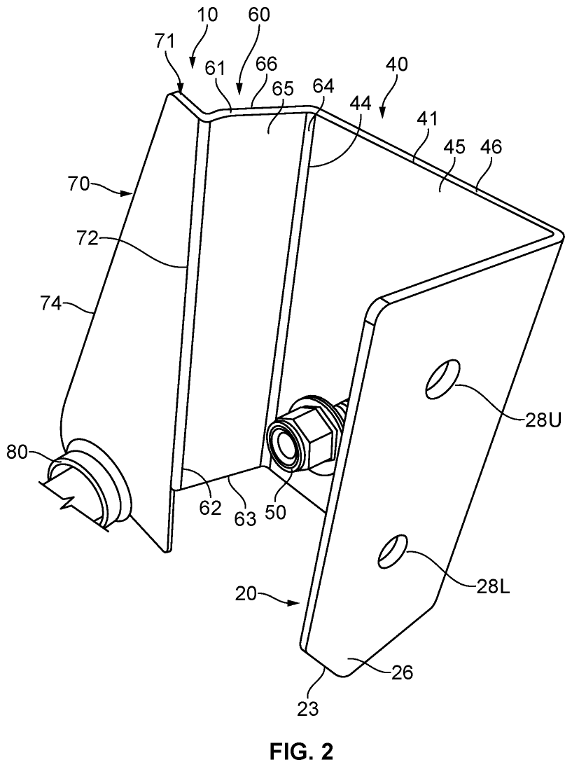

FIG. 1 is a side perspective view showing a tailgate security bracket assembly 10 of a first embodiment, in accordance with principles of the disclosure. Further, FIG. 2 is a further side perspective view showing the tailgate security bracket assembly of FIG. 1.

The tailgate security bracket assembly, as shown in FIG. 1, can include a bracket 11 and various support fasteners or attachment fasteners to attach the bracket 11 to a vehicle, so as to secure and prevent theft of a tailgate mounted on the vehicle. In particular, for example, the tailgate security bracket assembly of the disclosure can provide an anti-theft device to prevent a tailgate of a pickup truck from being stolen. The bracket 11 can include various components or plates. The bracket 11 can be constructed of a steel plate or sheet-metal that is bent or forged into shape—so as to form the configuration of the bracket 11 shown in FIG. 1. Alternatively, the bracket 11 could be cast in the shape shown in FIG. 1 or have the various plates welded together in the shape shown in FIG. 1.

Accordingly, the bracket assembly 10 of FIG. 1 can include the bracket 11 and various fastener mechanisms that serve to attach the bracket 11 onto the vehicle. As shown in the embodiment of FIG. 1, the bracket 11 can include a transverse attachment plate 20, a longitudinal attachment plate 40, a lateral plate 60, and a retainment plate 70. In an embodiment, the bracket 11 can attach to a rear corner structure, such as a rear corner structure of a cargo bed or bed of a pickup truck. More specifically, with the embodiment shown in FIG. 1, the transverse attachment plate 20, longitudinal attachment plate 40, and lateral plate 60 can “wrap around” the rear corner structure (on the passenger or right side) of the bed. As described below, the bracket 11 can be secured to the rear corner structure using suitable fastener mechanisms. Such fastener mechanisms, i.e. support fasteners or other mechanism, can include one or more threaded studs that extend from the bracket 11. For example, the threaded studs can be welded onto the bracket 11. Such fastener mechanisms can include one or more bolts with nuts. For example, part of the fastener mechanism can be accessed only by removing the rear taillight assembly on the side that the bracket 11 is to be mounted. Accordingly, removal of the bracket assembly is inhibited, and thus theft of the secured tailgate is inhibited, since a thief may well not have the time, tools or know-how to remove the rear light assembly from a pickup truck, not to mention removal of the tailgate security bracket assembly itself. Also, as described below, a fastener mechanism of the disclosure can include one or more “security nuts” that can afford further theft prevention. Such security nuts can be akin to a locking lug nut used to prevent the theft of a wheel on a vehicle.

Herein, various aspects of the disclosure are described in the context of a “pickup truck” or “pickup.” However, it is appreciated that the bracket assemblies of the disclosure can be used with any of a wide variety of vehicles that include a tailgate. It is appreciated that the shape and dimensions of the bed of a pickup truck, and vehicles in general, can vary widely. Accordingly, it is appreciated that the particular shape of the bracket assembly as shown in FIG. 1 and the other embodiments can vary depending on the particular shape and dimension of the particular vehicle and/or particular cargo bed to which the bracket assembly will be mounted. Further, the particular fastener mechanisms and/or point of attachment of the fastener mechanisms can vary depending on the particular vehicle to which the bracket assembly is to be attached. Accordingly, it is appreciated that the particular shape, dimensions, and attachment points shown in the embodiments described herein are for purposes of illustration and are not intended to be limiting.

In the embodiment shown in FIG. 1, the bracket 11 can include transverse attachment plate 20, longitudinal attachment plate 40, lateral plate 60, and retainment plate 70. The longitudinal attachment plate 40 can be physically disposed and attached to a rear corner structure (passenger/right side of the vehicle) on the inboard or inner side of such rear corner structure. The longitudinal attachment plate 40 can include an upper edge 41. The longitudinal attachment plate 40 can include a forward edge or connection edge 42. The forward edge 42 can be connected to the transverse attachment plate 20. As shown, the longitudinal attachment plate 40 and the transverse attachment plate 20 can be at 90° or right angle to each other. However, it is appreciated that in some embodiments, the bracket assembly 10 may not include the transverse attachment plate 20. That is, the transverse attachment plate 20 can be omitted from the bracket assembly 10 in some embodiments of the disclosure. For example, it may be desirable or needed to omit the transverse attachment plate 20 in a situation where the rear corner structure, e.g., the rear corner structure, of the bed is of consistent depth, inboard and outboard, along a side panel of the bed. That is, in other words, the side panel is of consistent thickness along the length of the side panel including the rear corner structure.

The longitudinal attachment plate 40 can include a lower edge 43. The longitudinal attachment plate 40 can include a back edge or connection edge 44. In particular, the back edge 44 is shown in FIG. 2. The longitudinal attachment plate 40 can include an outboard face 45 and an inboard face 46. The bracket assembly 10 can include a security fastener assembly, i.e. fastener mechanism, 50 which can be attached to the longitudinal attachment plate 40. The security fastener assembly 50 can include a threaded stud 51 that is welded to the outboard face 45 of the longitudinal attachment plate 40, as shown in FIG. 1 and in FIG. 2. The security fastener assembly 50 further includes a washer 54 to distribute the load of the fastener assembly 50. The fastener mechanism 50 can include a locknut 52. The locknut 52 can include a nylon insert 53 or other rotation preventative insert so that the locknut 52 cannot be rotated by hand. Such arrangement provides further theft prevention. That is, the threaded stud 51 can extend through the rear corner structure of the bed of the pickup and extend into a light assembly socket of the vehicle and secured with the locknut 52. Accordingly, for a thief to remove the bracket assembly 10 from the pickup, the thief must first remove the light assembly so as to access the light assembly socket. Thereafter, the thief must remove the locknut 52 from the stud 51. If the nut 52 was not a locknut, the thief could merely loosen the nut 52 and then remove the nut 52 by hand. However, in the case that the nut 52 is a locknut, the thief must rotate the locknut 52 with a wrench the entire length of the threaded shaft. Accordingly, the time involved to remove the locknut 52 can exceed the time that the thief has at their disposal. The time required to remove the locknut 52 can be further amplified if the length of the threaded shaft is increased.

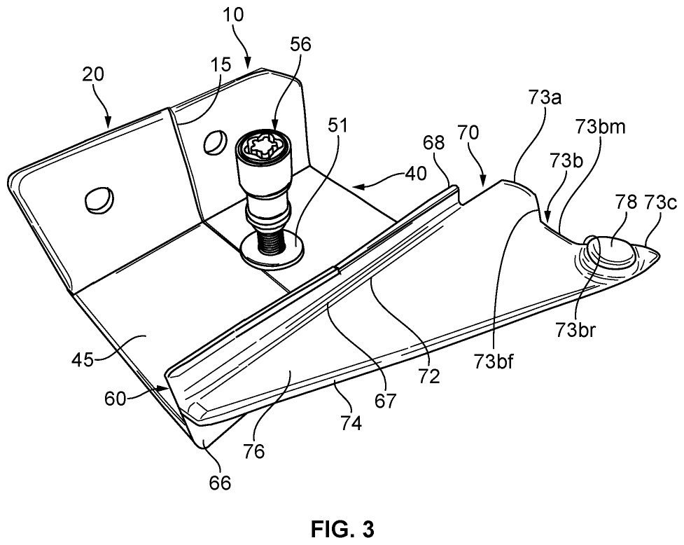

Additionally, in lieu of the locknut 52 shown in FIG. 1, a locking lug nut or keyed nut can be utilized. Such keyed nut is illustratively shown in the arrangement of FIG. 3, for example. Such keyed nut requires a particular tool or particular socket to be used for removal of such keyed nut. Accordingly, such feature can further increase the burden imposed on a thief to remove the bracket assembly 10, so as to, in turn, be able to remove the tailgate of the pickup or other vehicle.

In the embodiment shown in FIG. 1, the bracket 11, of the bracket assembly 10, can include the transverse attachment plate 20. The transverse attachment plate 20 can include an upper edge 21, an outboard edge 22, and a lower edge 24. The transverse attachment plate 20 can include a chamfer edge 23. The chamfer edge 23 can also be described as a relief 23, so as to be able to be positioned into the corner of the bed. The chamfer edge 23 can be considered to be part of the outboard edge 22 and/or the lower edge 24. The transverse attachment plate 20 can also include the inboard edge 25. The inboard edge 25 can be described as a connection edge 25 that serves to connect the transverse attachment plate 20 to the longitudinal attachment plate 40. The transverse attachment plate 20 can include a forward face 26. The “forward” face 26 can be described as such since the face 26 faces forward on the vehicle. The transverse attachment plate 20 can also include a back face 27. The back face 27 can be pressed up against a forward face of the rear corner structure of the vehicle or pickup truck. However, as described above, it may be the case that the side panel of the bed is of consistent depth, i.e., such that there is no forward face of the rear corner structure of the pickup. In such situation, it is appreciated that the transverse attachment plate 20 can be omitted.

The transverse attachment plate 20 can include attachment or mount holes. The attachment holes can include an upper attachment hole 28U and a lower attachment hole 28L. The attachment holes 28U, 28L can receive a suitable, respective, fastener mechanism or fastener assembly. Such fastener mechanism can include a bolt that passes through each of the attachment holes 28U, 28L. Such bolt can pass into the rear corner structure of the vehicle so as to be accessible by removing the rear tail light assembly of the vehicle. That is, the rear tail light assembly of the vehicle can be removed so as to access the rear tail light socket, i.e. tail light pocket, of the rear corner structure, and so as to thread a suitable nut onto the bolt.

The bracket 11, of the tailgate security bracket assembly 10, can include a lateral plate 60. As otherwise described herein, the dimensions and in particular the width of the lateral plate 60 can vary depending on the particular dimensions of the bed of the vehicle. More specifically, the dimensions of the lateral plate 60 can vary depending on the width of the side panel of the bed of the vehicle. In an embodiment, the dimensions of the lateral plate 60 can be such that the retainment plate 70 is positioned over the tailgate pin on the passenger-side of the vehicle, so as to enclose or surround the tailgate pin on the passenger side. Accordingly, if the side panel of the bed is deep, inboard to outboard, then the width of the lateral plate 60, inboard to outboard, can also be deep—as compared to the side panel of another vehicle that is of thinner or smaller dimension, inboard to outboard.

The lateral plate 60 can include an upper edge 61 and a lower edge 63. The lateral plate 60 can also include an outboard edge 62. The outboard edge 62 can be described as a connection edge or a first connection edge 62. The first connection edge 62 serves to connect the lateral plate 60 to the retainment plate 70. The lateral plate 60 can also include an inboard edge 64. The inboard edge 64 can be described as a connection edge or a second connection edge 64. The second connection edge 64 serves to connect the lateral plate 60 to the longitudinal attachment plate 40.

The lateral plate 60 can also include a forward face 65. The forward face 65 can be forward facing. Accordingly, the forward face 65 can be pressed up against a surface of the bed of the pickup truck. More specifically, the forward face 65, of the lateral plate 60, can be pressed up against the rear corner structure of the bed of the pickup truck.

The lateral plate 60 can also include a back face 66. The back face 66, of the lateral plate 60, can be pressed against the tailgate and or positioned in close proximity to the tailgate when the tailgate is closed.

Additionally, the bracket 11, of the tailgate security bracket assembly, can include the retainment plate 70. The retainment plate 70 can include an upper edge 71. The retainment plate 70 can also include a forward edge 72. The forward edge 72 can be connected to the lateral plate 60. More specifically, the forward edge 72, of the retainment plate 70, can be connected to the first connection edge 62, of the lateral plate 60.

The retainment plate 70 can also include a lower edge. The lower edge can include a front edge segment 73a, a curved edge segment or curved segment 73b, and a rear edge segment 73c. The curved edge segment 73b can provide a slot or securement slot 79, i.e., a retaining slot 79, into which the pin or tailgate pin of the tailgate (of the vehicle) can be received. The size of the securement slot 79 can vary depending on the particular size of the tailgate pin, on the particular side of the tailgate to which the tailgate security bracket assembly is to be mounted. For example, the tailgate security bracket assembly can be mounted on the passenger-side of the vehicle.

Accordingly, the curved edge segment 73b can form a securement slot 79. The securement slot 79 can be a semicircular shape as shown in FIG. 1. The securement slot 79 can be of a shape as illustratively shown in FIG. 3, for example. Further details are described below. In the embodiment of FIG. 1, a retainment flange 80 can be disposed in the securement slot 79, so as to reinforce the retainment plate 70. That is, the retainment flange 80 can be welded, for example, to the curved edge segment 73b of the retainment plate 70. The retainment flange 80 can be connected to the retainment plate 70 so as to extend inboard and/or outboard of the retainment plate 70. It is appreciated that other attachment or fastener mechanisms can be used to attach the retainment flange 80 onto the retainment plate 70. For example, “L” shaped brackets could be used to attach the retainment flange 80 onto the retainment plate 70. Such brackets could be attached to the retainment flange 80 and/or the retainment plate 70 by welding. Such brackets could be attached to the retainment flange 80 and/or the retainment plate 70 by any suitable mechanical fastener, such as a screw or nut/bolt.

The retainment flange 80 can also be described as a collar or retainment collar 80. The retainment flange 80 can include a lower curved, concave surface 81, as shown in FIG. 1. The lower surface 81 can provide a pin contact surface that can be in contact with the pin of the tailgate. It may be the case that a collar, along with the socket that retains the tailgate) surrounds the pin of the tailgate. Accordingly, the lower surface 81 can be in contact with such collar, socket and/or the tailgate pin that the collar surrounds and encases. For example, with some tailgates a plastic collar can surround the tailgate pin (or portion thereof) of the tailgate.

The retainment flange 80 can also include upper curved surface or upper surface 82. The upper surface 82, of the retainment flange 80, can be the surface that is welded onto the retainment plate 70.

The retainment flange 80 can include a forward edge and a back edge. The retainment flange 80 can include an outboard retainment flange edge 83 and an inboard retainment flange edge 84. In the case that the retainment flange 80 only extends outboard of the retainment plate 70, the inboard retainment flange edge 84 can correspond to a connection edge (of the retainment flange 80) that is welded or otherwise connected to the retainment plate 70. In the case that the retainment flange 80 extends inboard from the retainment plate 70, then the inboard retainment flange edge, of the retainment flange 80, can be inboard of a connection or weld line at which the retainment flange 80 is connected to the retainment plate 70.

As described above, the lower surface 81 (of the retainment flange 80) can be in contact with the tailgate pin, socket that retains the tailgate pin, and/or a collar that surrounds the tailgate pin. Accordingly, the lower surface 81 can be coated with friction reducing material so as to better allow rotation of the tailgate pin within the confines of the retainment flange 80. For example, the surface 81 could be coated with a nylon coating so as to reduce friction between the surface 81 and the tailgate pin. Grease or oil might also be used to reduce friction between the surface 81 and the tailgate pin.

With further reference to FIGS. 1 and 2, the retainment plate 70 can also include a back edge 74. The back edge 74 can be curved or dimensioned so as to match the body shape of the particular vehicle. More specifically, the back edge 74 can be shaped so as to match the shape of a back of the rear corner structure (of the bed) of the particular vehicle. The back edge 74 and the top or upper edge 71 can be separated by an edge or corner, as shown in FIG. 1.

The retainment plate 70 can include an outboard face 76 and an inboard face 77. The retainment flange 80 can extend outboard from the outboard face 76 and/or the retainment flange 80 can extend inboard from the inboard face 77.

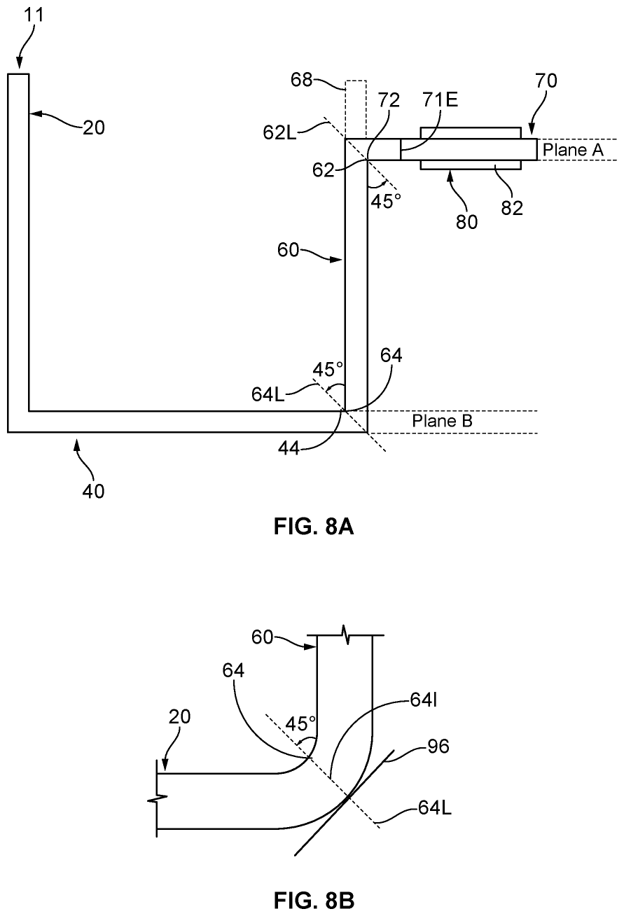

As shown in FIGS. 1 and 2, the retainment plate 70 can be connected to the lateral plate 60 such that the lateral plate 60 extends only inboard from the retainment plate 70. In other words, an outboard edge 62, of the lateral plate 60, can be connected to the retainment plate 70 such that the lateral plate 60 only extends inboard from the retainment plate 70. Such arrangement is shown in the embodiment of FIG. 1, as well as the embodiment of FIG. 8. In other embodiments, such as the embodiment of FIG. 3, a lateral extension portion 68, i.e., a lateral extension 68, of the lateral plate 60 can extend outboard from the first connection edge 62 (of the lateral plate 60) at which location the retainment plate 70 is attached to the lateral plate 60. The lateral extension 68 can provide a reinforcing structure, which can also be described as a reinforcing rib 68, and can serve to further enclose and engage with the rear corner structure of the bed of the vehicle. The lateral extension 68 is shown in phantom in FIG. 8A. Further details are described below with reference to FIG. 3.

FIG. 3 is a side perspective view showing a tailgate security bracket assembly of a second embodiment, in accordance with principles of the disclosure. The tailgate security bracket assembly of FIG. 3 can be similar in various ways to the tailgate security bracket assembly of FIG. 1. However, for example, the tailgate security bracket assembly of FIG. 3 can include the lateral extension 68, i.e. a reinforcing rib 68. The lateral extension 68 can extend outboard from the first connection edge 62 at which the lateral plate 60 is connected to the retainment plate 70. In other words, the lateral extension 68 can extend outboard from a line or elongated area, of the lateral plate 60, at or along which the retainment plate 70 is attached. The retainment plate 70 comprises a groove 67 at a portion of the retainment plate 70 connected to the lateral plate 60.

The tailgate security bracket assembly of FIG. 3 can include a securement slot (see 79 of FIGS. 1 and 2). The securement slot of FIG. 3 can be different in structure as compared to the securement slot 79 of FIG. 1. For example, the securement slot of the embodiment in FIG. 3 does not need to include the retainment flange or collar (see 80 of FIGS. 1 and 2). That is, in the embodiment of FIG. 3, the retainment flange can be omitted. Further, the geometry or shape of the securement slot of the embodiment of FIG. 3 can be different as compared to FIG. 1. For example, the securement slot 3 can include a curved edge segment 73b that can be comprised of both curve segments and straight segments so as to collectively generate the securement slot into which a tailgate pin can be received. As shown in FIG. 3, the curved edge segment 73b can include a front edge 73bf; a center or middle edge 73bm, and a rear edge 73br. Accordingly, the front edge 73bf, the middle edge 73bm, and the rear edge 73br can form a securement slot to receive a tailgate pin.

As shown in FIG. 3, the retainment plate 70 can also include, or have mounted thereon, a retainment knob 78. The retainment knob 78 can serve to further reinforce the distal end or rear corner of the retainment plate 70. Further, the retainment knob 78 can be sized and positioned so as to inhibit a thief from using a prybar to pry off the tailgate that the thief is attempting to steal.

FIG. 3 also illustrates that the various components of the tailgate security bracket assembly, as disclosed herein, can be constructed of one or more pieces. As described above, for example, the bracket 11 of embodiment can be constructed of a single piece of sheet metal that is bent into the shape as shown in FIG. 1. As illustrated in FIG. 3, in accordance with one illustrative construct of a bracket 11 of the disclosure, a top half of transverse attachment plate 20, a top half of longitudinal attachment plate 40 and a top half of lateral plate 60 can be provided by a first U-shaped bracket. A bottom half of transverse attachment plate 20, a bottom half of longitudinal attachment plate 40 and a bottom half of lateral plate 60 can be provided by a second U-shaped bracket, as shown in FIG. 3. The first U-shaped bracket and the second U-shaped bracket can then be welded or otherwise bonded together along a joint line 15, as shown in FIG. 3. Thereafter, the retainment plate 70 can be welded or otherwise bonded onto the lateral plate 60. It is appreciated that other construct methodologies can be used in the construct of the tailgate security bracket assembly disclosure.

As shown in FIG. 3, the tailgate security bracket assembly can include a threaded stud 51. In similar manner to the tailgate security bracket assembly of FIG. 1, the threaded stud 51 of FIG. 3 can extend into and be received by a rear corner structure of the bed of a vehicle. As described above, the threaded stud 51 can be accessed via the tail light socket, i.e. once the rear tail light assembly is removed from the tail light socket of the vehicle. As illustrated in FIG. 3, a keyed nut 56 can be used so as to secure the tailgate security bracket assembly onto the bed of the truck. That is, structure of the rear corner structure (of the bed of the vehicle) can be “sandwiched” between the longitudinal attachment plate 40 and the nut 56 so as to secure the tailgate security bracket assembly 10 onto the rear corner structure of the vehicle. It is appreciated that washers, locking washers, and/or other faster mechanisms can be utilized so as to assist in the securement of the tailgate security bracket assembly onto the bed of the vehicle.

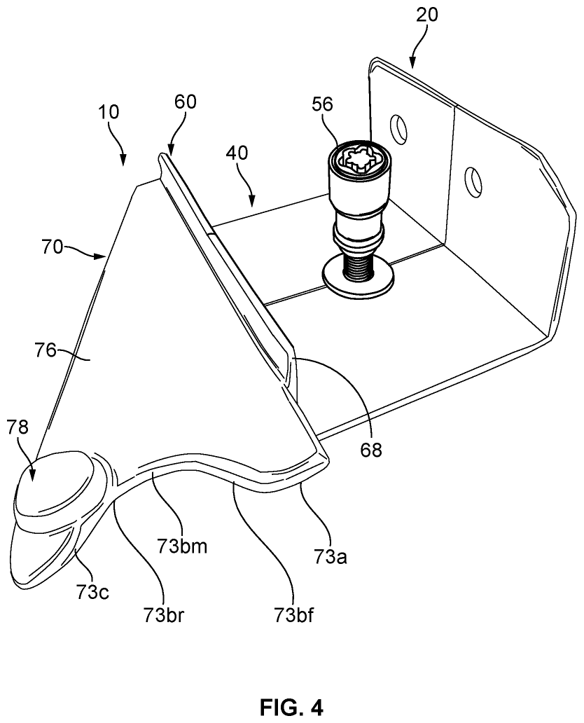

FIG. 4 is a bottom perspective view showing the tailgate security bracket assembly of FIG. 3, in accordance with principles of the disclosure. FIG. 4 shows further aspects of the curved edge segment 73b that provides a securement slot 79 into which a tailgate pin of the tailgate is received. Further, FIG. 4 illustrates the lateral extension 68, described above, that can extend outboard of the retainment plate 70. The lateral extension 68 can provide a reinforcing rib 68 and serve to further enclose and engage with the rear corner structure, for example a rear corner column, of the vehicle.

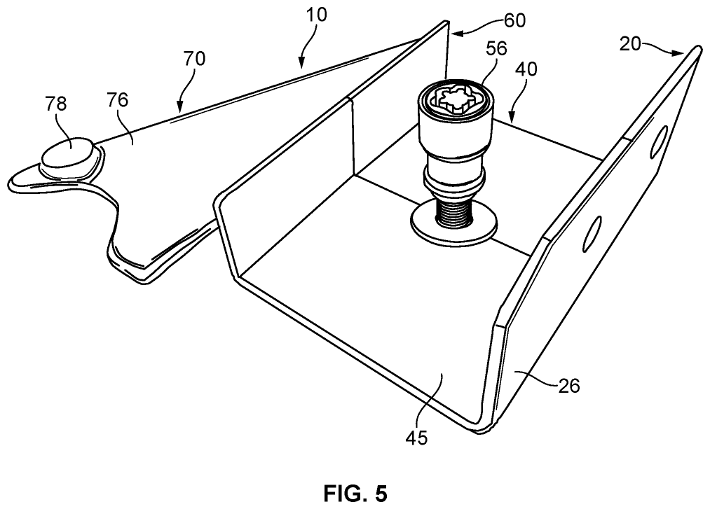

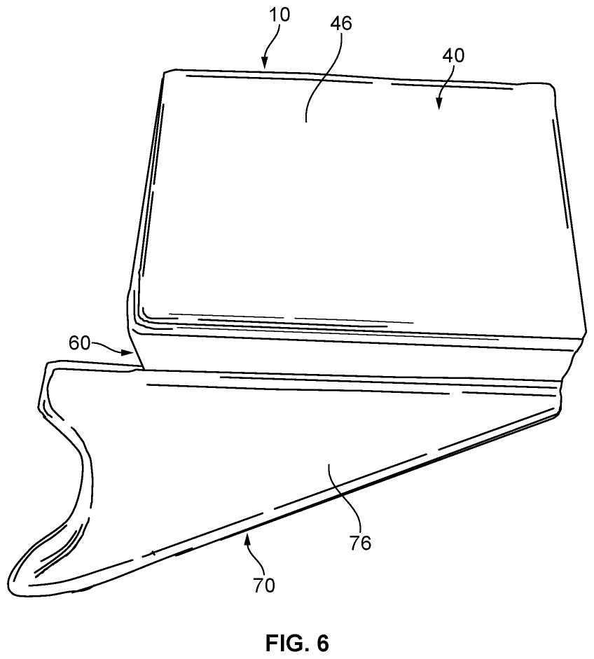

FIG. 5 is a further bottom perspective view showing the tailgate security bracket assembly of FIG. 3, in accordance with principles of the disclosure. FIG. 6 is a back perspective view showing the tailgate security bracket assembly of FIG. 3, in accordance with principles of the disclosure.

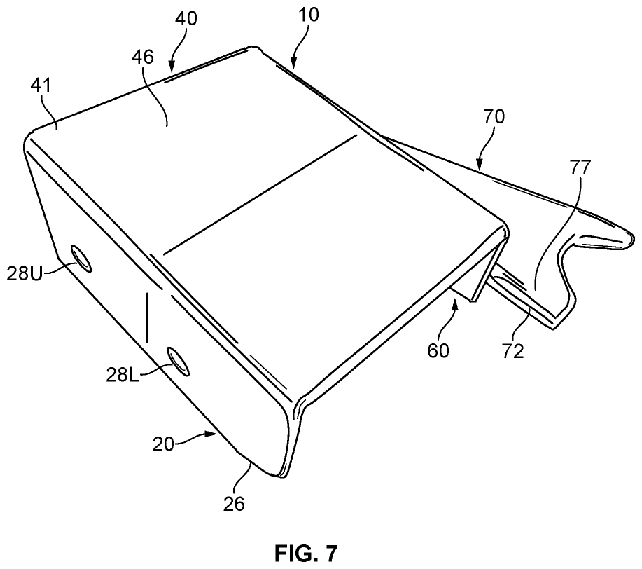

FIG. 7 is a bottom perspective view showing the tailgate security bracket assembly of FIG. 3, in accordance with principles of the disclosure. In particular, FIG. 7 shows that the retainment plate 70 can extend downward from a lower edge 63 of the lateral plate 60. For example, the lower edge 63 of the lateral plate 60 can be slightly above the “floor” of the bed of the vehicle. The tailgate security bracket assembly 10 can be attached at a height so as to allow a pad, liner or mat to be disposed on the floor of the bed of the vehicle, while still allowing the retainment plate 70, and specifically the securement slot 79, to securely engage with pin of the tailgate.

FIG. 8 is a top view “schematic” diagram showing a bracket 11 the same as or similar to the bracket shown in FIG. 1, in accordance with principles of the disclosure. As shown in FIG. 8, the bracket 11 can include the transverse attachment plate 20, the longitudinal attachment plate 40, the lateral plate 60, and the retainment plate 70. The transverse attachment plate 20 can be connected at 90° or at right angle to the longitudinal attachment plate 40. The lateral plate 60 can be connected at 90° or at right angle to the longitudinal attachment plate 40. Additionally, the lateral plate 60 can be connected at 90° or at right angle to the retainment plate 70. As noted above, FIG. 8 also illustrates (in phantom) the lateral extension 68 that can optionally be provided, such as is shown in the arrangement of FIG. 3, for example. As otherwise described herein, a forward edge 72 of the retainment plate 70 can be connected to a first connection edge 62 of the lateral plate 60. A back edge 44 of the longitudinal attachment plate 40 can be connected to a second connection edge 64 of the lateral plate 60. In the bracket 11 of FIG. 8, separation of the lateral plate 60 vis-à-vis the longitudinal attachment plate 40 can be defined by an inner corner and/or in outer corner of the illustrative “joint” between the lateral plate 60 and the longitudinal attachment plate 40.

However, it is appreciated that in some embodiments of the bracket 11 of the disclosure, the different plates 20, 40, 60, 70 of the disclosed bracket can be constructed of bent sheet-metal. With such construct, as illustratively shown in FIG. 8B, an edge of a particular plate can be described as follows.

An edge of a plate, along the surface of the particular plate, can be described as a collection of points (along the surface of the plate) at which a horizontal tangent of the curve of the surface deviates at least forty-five (45) degrees from an angle (of a plane) in which the particular plate is positioned. Such an edge can be defined on both sides of a particular plate. Further, an edge in the interior (between opposing sides or surfaces) of a particular plate, i.e., an interior edge, can be defined, as shown in FIG. 8B, by a line that connects an inner edge to an outer edge. Accordingly, a clear demarcation between a first plate and a second plate can be provided and/or defined.

For example, with reference to FIG. 8A and FIG. 8B, an edge 64 of lateral plate 60, along the surface of the particular plate, can be described as a collection of points (along the surface of the lateral plate 60) at which a horizontal tangent 96 of the curve of the surface deviates at least forty-five (45) degrees from an angle (of a plane) in which the lateral plate 60 is positioned. Such an edge 64 can be defined on both sides of a particular plate. Further, an edge 64 in the interior of a particular plate, i.e., an interior edge 641 as shown in FIG. 8B, can be defined, as shown in FIG. 8B, by a line 64L that connects an inner edge to an outer edge. Accordingly, a clear demarcation between a lateral plate 60 and a longitudinal attachment plate 40 can be provided and/or defined.

As shown in FIG. 8A, the retainment plate 70 can be positioned in a first plane or plane A. The longitudinal attachment plate 40 can be positioned in a second plane or plane B. The retainment plate 70 and the longitudinal attachment plate 40 can be parallel to each other, i.e. the first plane and the second plane can be parallel to each other.

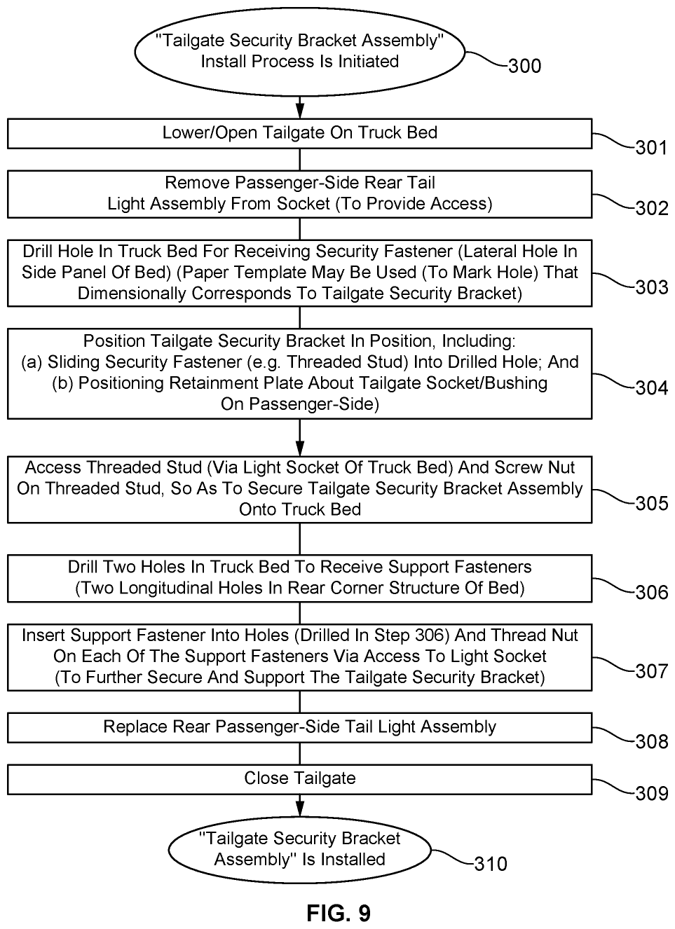

FIG. 9 is a flowchart showing a tailgate security bracket assembly install process of at least one embodiment of the disclosure, in accordance with principles of the disclosure. The install process is initiated in step 300 and passes to step 301.

In step 301, the tailgate can be opened or lowered so as to access the bed of the vehicle, and in particular so as to access the right-side panel of the vehicle.

In step 302, remove passenger-side rear tail light assembly from the tail light socket. Then, in step 303, drill hole in truck bed for receiving security fastener/assembly 50. That is, such hole can be a lateral hole in the side panel of the vehicle or truck bed (or truck bed rear column). A paper template may be used (to mark hole position) that dimensionally corresponds to tailgate security bracket.

Then, in step 304, position tailgate security bracket in position, including: (a) sliding security fastener (e.g., threaded stud) into the drilled hole; and (b) positioning retainment plate about tailgate socket/bushing on passenger-side). Then, in step 305, access threaded stud (via taillight socket of truck bed) and screw nut onto the threaded stud, so as to secure tailgate security bracket assembly onto truck bed. Accordingly, the longitudinal attachment plate 40 can be attached to the vehicle.

Then, in step 306, drill two holes in truck bed to receive support fasteners 30 (i.e., drill two longitudinal holes in rear corner structure of bed). Then, in step 307, insert support fastener into holes (drilled in step 306) and thread nut on each of the support fasteners via access to light socket (to further secure and support the tailgate security bracket). Accordingly, the transverse attachment plate 20 can be attached to the vehicle.

Then, in step 308, replace rear passenger-side tail light assembly, and in step 309, close the tailgate. As a result, in step 310, the tailgate security bracket assembly is installed.

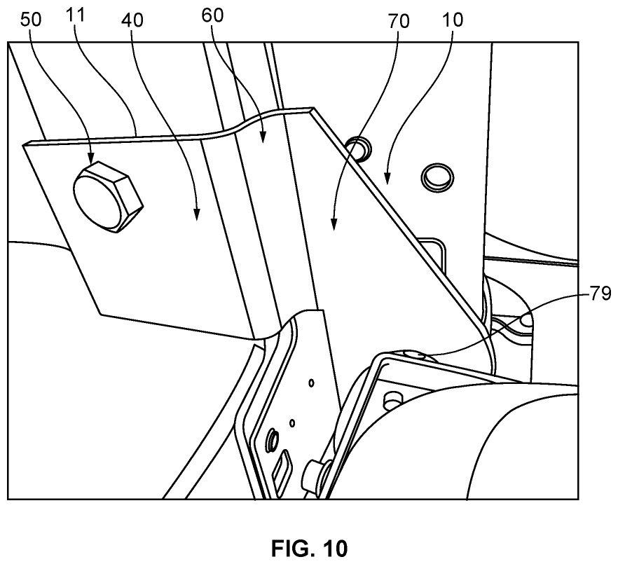

FIG. 10 is a side perspective view showing a tailgate security bracket assembly 10 of a third embodiment, installed on a vehicle, in accordance with principles of the disclosure. The assembly 10 can include longitudinal attachment plate 40, lateral plate 60, and retainment plate 70. In the tailgate security bracket assembly of FIG. 10, the corners between the plates can be more rounded as compared to the embodiment of FIG. 8, for example. For example, the bracket 11, of the tailgate security bracket assembly 10 of FIG. 10, can be constructed of a single plate or sheet of steel that is bent or forged into the shape shown in FIG. 10.

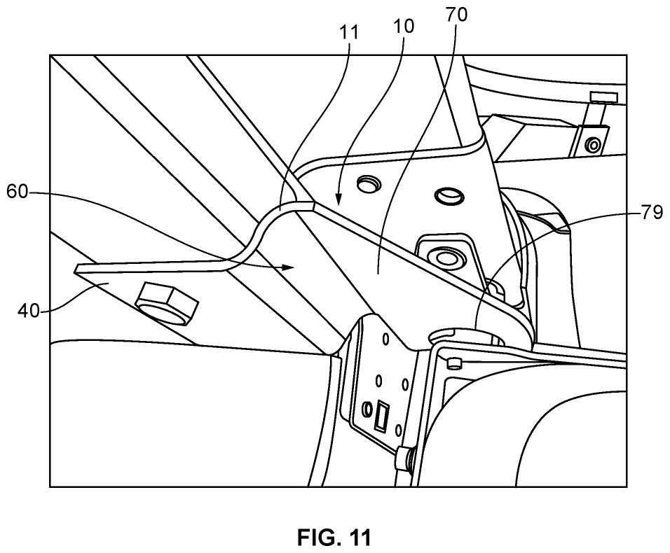

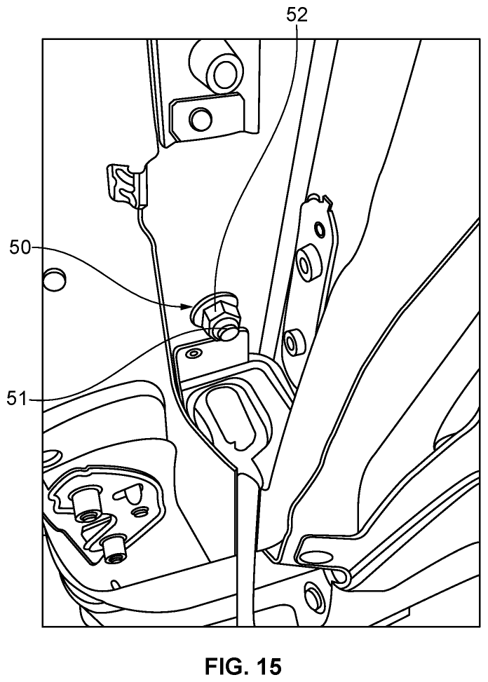

FIG. 10 also shows a fastener mechanism 50, i.e., a security fastener assembly 50, that can extend through the longitudinal attachment plate 40 and into the rear corner structure of the pickup or other vehicle. As shown in FIG. 10, as well as in FIGS. 11, 12 and 14, the fastener mechanism 50 can include a bolt with nut. However, it is appreciated that the fastener mechanism 50 can instead be some other fastener mechanism including, in particular, a threaded stud such as is shown in FIG. 3. The threaded stud can extend from an outboard face of the longitudinal attachment plate 40, as described above, through the rear corner structure of the vehicle, and into the tail light socket, as shown in FIG. 15.

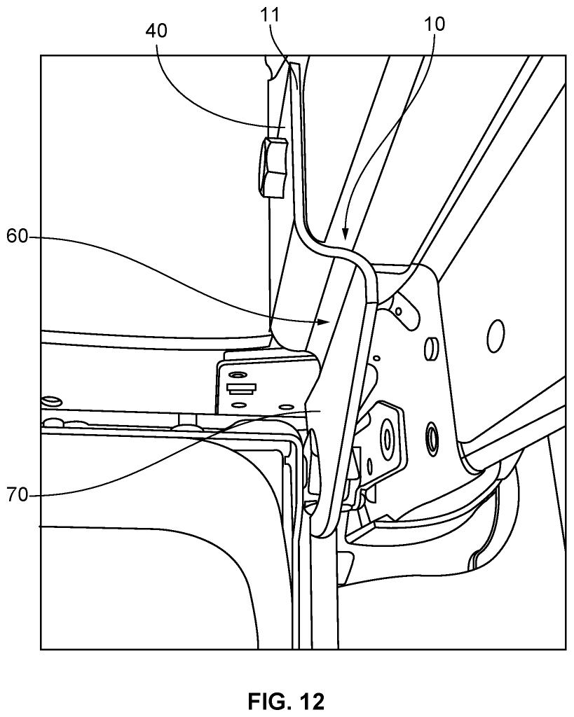

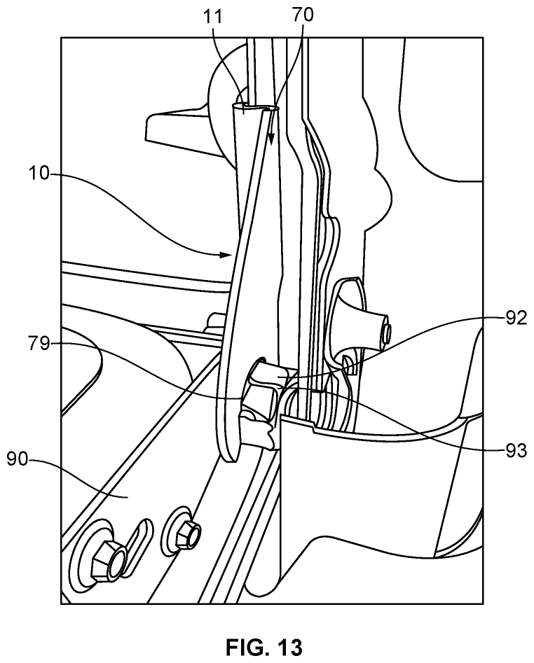

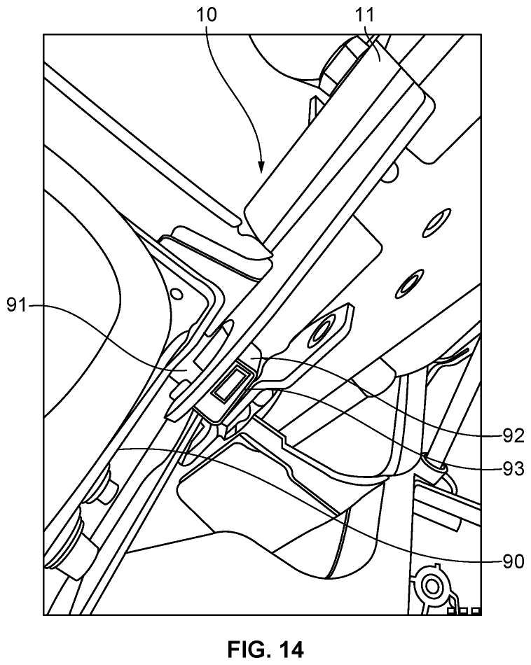

FIG. 11 is a top perspective view showing the tailgate security bracket assembly 10 of FIG. 10, in accordance with principles of the disclosure. FIG. 12 is a back perspective view showing the tailgate security bracket assembly 10 of FIG. 10, in accordance with principles of the disclosure. FIG. 13 is a further back perspective view showing the tailgate security bracket assembly 10 of FIG. 10, in accordance with principles of the disclosure. Also, FIG. 14 is a further back perspective view showing the tailgate security bracket assembly 10 of FIG. 10, in accordance with principles of the disclosure.

As shown in FIGS. 13 and 14, the tailgate security bracket assembly 10 includes retainment plate 70 with securement slot 79 that surrounds the right tailgate pin 91 of a tailgate 90. The socket 92 can include a groove 93. As described above, it is groove 93 that allows pin 91 of the tailgate to be removed from the socket 92. As shown in FIG. 13 in particular, the retainment plate 70 with slot 79 can engage with the socket 92 and/or the pin 91—so as to prevent the pin 91 from being removed from the socket 92. Accordingly, theft of the tailgate 90 can be prevented. In some arrangements of the assembly 10, the retainment plate 70 can engage and surround only the socket 92, i.e., not be in physical contact with the tailgate pin in normal operation of the tailgate. In some arrangements of the assembly 10, the retainment plate 70 can engage and surround the tailgate pin 91 itself, i.e., the retainment plate 70 can be in in physical contact with the tailgate pin in normal operation of the tailgate. However, in any of such arrangements, the retainment plate 70 of the tailgate security bracket assembly 10 can prevent the removal of the pin 91 from the socket 92, and thus prevent theft of the tailgate.

As noted above, FIG. 15 is a side perspective view from inside the taillight cavity showing a fastener mechanism 50 (of the tailgate security bracket assembly 10 of FIG. 10) that extends into the tail light socket, in accordance with principles of the disclosure. That is, FIG. 15 shows the threaded shaft 51 of a bolt or stud of fastener mechanism 50. The fastener mechanism 50 can include a nut 52 that can be in the form of a locknut or keyed security nut, as described above. It is appreciated that one fastener (or fastener mechanism) as described herein can be interchanged with another fastener (or fastener mechanism) as may be desired. Accordingly, for example, a bolt with nut can be interchanged with a welded stud with nut, for example.

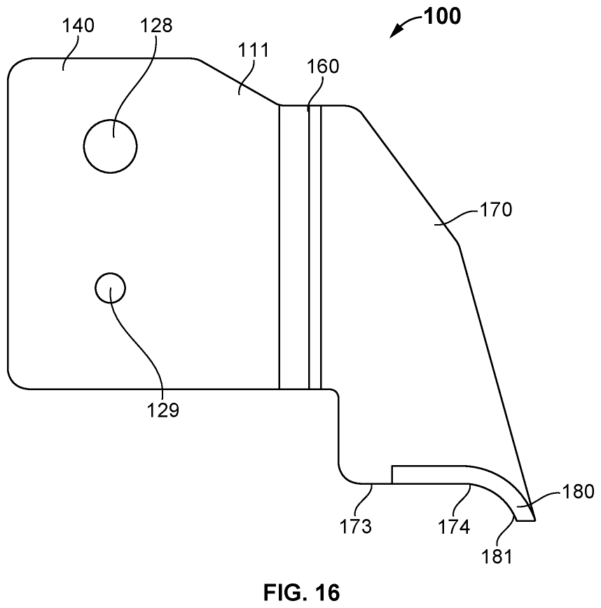

FIG. 16 is a side view of a tailgate security bracket assembly 100 of yet another embodiment, in accordance with principles of the disclosure. Tailgate security bracket assembly 100 comprises a bracket 111 and various support fasteners or attachment fasteners to attach the bracket 110 to a vehicle, so as to secure and prevent theft of a tailgate mounted on the vehicle. Tailgate security bracket assembly 100 can include a longitudinal attachment plate 140, a lateral plate 160, and a retainment plate 170. The bracket 111 can attach to a rear corner structure, such as a rear corner structure, of a cargo bed or bed of a pickup truck. More specifically, the longitudinal attachment plate 140, and lateral plate 160 can “wrap around” the rear corner structure (on the passenger or right side) of the truck bed. The bracket 111 can be secured to the rear corner structure using suitable fastener mechanisms. Such fastener mechanisms, i.e. support fasteners or other mechanisms, can include one or more threaded studs that extend from or through the attachment plate 140. For example, the threaded stud can be welded onto the attachment plate 140 or a hole 128 can be designed into the attachment plate 140 allowing a threaded bolt to be placed through the plate 140. Such fastener mechanisms can include one or more bolts with nuts. For example, part of the fastener mechanism can be accessed only by removing the rear taillight assembly on the side that the bracket 111 is to be mounted.

Accordingly, removal of the bracket assembly 111 is inhibited, and thus theft of the secured tailgate is inhibited, since a thief may well not have the time, tools or know-how to remove the rear light assembly from a pickup truck, not to mention removal of the tailgate security bracket assembly itself. Also, as described below, a fastener mechanism of the disclosure can include one or more “security nuts” that can afford further theft prevention. Such security nuts can be akin to a locking lug nut used to prevent the theft of a wheel on a vehicle.

The attachment plate 140 could also include a pin 129 which could be welded to the attachment plate 140. The pin 129 would slot or insert into a hole in the truck bed wall column (i.e., by the taillight frame) to prevent the attachment plate 140 from rotating or pivoting around the connecting bolt and nut inserted through hole 128. The pin 129 might require an additional hole to be drilled into the truck bed column attachment point. Alternatively, the pin 129 could be a second hole through which an additional bolt and nut securing fastener is used.

In the embodiment shown in FIG. 16, bracket 111 can include longitudinal attachment plate 140, lateral plate 160, and retainment plate 170. As previously described above in relation to FIGS. 1 and 2, the longitudinal attachment plate 140 is adjacent to or connected to the lateral plate 160 which is adjacent to or attached to the retainment plate 170. The attachment plate 140, lateral plate 160, and retainment plate 170 could be fabricated from one piece of metal and bent to create the three plates 140, 160, 170. The attachment plate 140 can be physically disposed and attached to a rear corner structure (passenger/right side of the vehicle) on the inboard or inner side of such rear corner structure.

The bracket 111, of the tailgate security bracket assembly 100, can include a lateral plate 160. As otherwise described herein, the dimensions and in particular the width of the lateral plate 160 can vary depending on the particular dimensions of the bed of the vehicle. More specifically, the dimensions of the lateral plate 60 can vary depending on the width of the side panel of the bed of the vehicle. In an embodiment, the dimensions of the lateral plate 160 can be such that the retainment plate 170 is positioned over the tailgate pin on the passenger-side of the vehicle, so as to enclose or surround the tailgate pin on the passenger side. Accordingly, if the side panel of the bed is deep, inboard to outboard, then the width of the lateral plate 160, inboard to outboard, can also be deep—as compared to the side panel of another vehicle that is of thinner dimension, inboard to outboard.

Additionally, the bracket 111, of the tailgate security bracket assembly 100, can include the retainment plate 170. The retainment plate 170 can also include a lower edge 173. The lower edge can include a curved edge segment or curved segment 174. The curved edge segment 174 into which the pin or tailgate pin of the tailgate (of the vehicle) can be received. The size of the curved edge segment 174 can vary depending on the particular size of the tailgate pin, on the particular side of the tailgate to which the tailgate security bracket assembly is to be mounted. For example, the tailgate security bracket assembly can be mounted on the passenger-side of the vehicle.

Accordingly, the curved edge segment 174 can be a semicircular shape as shown in FIG. 16. The curved edge segment 174 can also include a retainment flange 180, so as to reinforce the retainment plate 70. That is, the retainment flange 180 can be welded, for example, to the curved edge segment 174 of the retainment plate 170. The retainment flange 180 can be connected to the retainment plate 170 so as to extend inboard and/or outboard of the retainment plate 170. It is appreciated that other attachment or fastener mechanisms can be used to attach the retainment flange 180 onto the retainment plate 70. For example, “L” shaped brackets could be used to attach the retainment flange 180 onto the retainment plate 170. Such brackets could be attached to the retainment flange 180 and/or the retainment plate 170 by welding. Such brackets could be attached to the retainment flange 180 and/or the retainment plate 170 by any suitable mechanical fastener, such as a screw or nut/bolt.

Various disclosure provided herein describes the tailgate security bracket assembly of the disclosure being positioned on the right or passenger side of the vehicle. However, it is appreciated that depending on the particular arrangement of the tailgate of the vehicle, the tailgate security bracket assembly of the disclosure may be reversed, and positioned on the driver or left side of the vehicle. In such arrangement, the bracket 11, 111 would be a “mirror image” in structure as compared to a bracket 11, 111 for use on the passenger side.

As described above, the transverse attachment plate 20 may be optional. In accordance with at least one embodiment of the disclosed subject matter, the transverse attachment plate 20 may be attached to the longitudinal attachment plate 40 with brackets and/or fasteners—so that if the transverse attachment plate 20 is not needed or desired, the transverse attachment plate 20 can be removed (and/or added at a later time).

The tailgate security bracket assembly of the disclosure can be added after-market and/or after manufacture of a vehicle. However, it is appreciated that the tailgate security bracket assembly of the disclosure can be integrated into a vehicle during manufacture of the vehicle.

It is appreciated that the various components of embodiments of the disclosure may be made from any of a variety of materials including, for example, metal, steel, iron, plastic resin, nylon, composite material, foam, rubber, elastic material, wood, leather, cardboard and/or ceramic, for example, or any other material as may be desired. A variety of production techniques may be used to make the apparatuses as described herein. For example, suitable casting, forging, bending and other manufacturing techniques and/or processes might be utilized. Also, the various components of the apparatuses or assemblies described herein may be integrally formed, as may be desired. Also, the various components of the apparatuses may be formed in pieces and connected together in some manner, such as with suitable fastener and/or brackets, for example. The various apparatuses and components of the apparatuses, as described herein, may be provided in various sizes and/or dimensions, as desired, in particular depending on the geometry of the particular vehicle on which the tailgate security bracket assembly will be used.

It will be appreciated that features, elements and/or characteristics described with respect to one embodiment of the disclosure may be variously used with other embodiments of the disclosure as may be desired.

It will be appreciated that the effects of the present disclosure are not limited to the above-mentioned effects, and other effects, which are not mentioned herein, will be apparent to those in the art from the disclosure and accompanying claims.

Although the preferred embodiments of the present disclosure have been disclosed for illustrative purposes, those skilled in the art will appreciate that various modifications, additions and substitutions are possible, without departing from the scope and spirit of the disclosure and accompanying claims.

It will be understood that when an element or layer is referred to as being “on” another element or layer, the element or layer can be directly on another element or layer or intervening elements or layers. In contrast, when an element is referred to as being “directly on” another element or layer, there are no intervening elements or layers present.

It will be understood that when an element or layer is referred to as being “onto” another element or layer, the element or layer can be directly on another element or layer or intervening elements or layers. Examples include “attached onto”, secured onto”, and “provided onto”. In contrast, when an element is referred to as being “directly onto” another element or layer, there are no intervening elements or layers present. As used herein, “onto” and “on to” have been used interchangeably.

It will be understood that when an element or layer is referred to as being “attached to” another element or layer, the element or layer can be directly attached to another element or layer or intervening elements or layers. In contrast, when an element is referred to as being “attached directly to” another element or layer, there are no intervening elements or layers present. It will be understood that such relationship also is to be understood with regard to: “secured to” versus “secured directly to”; “provided to” versus “provided directly to”; and similar language.

As used herein, the term “and/or” includes any and all combinations of one or more of the associated listed items.

It will be understood that, although the terms first, second, third, etc., may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section could be termed a second element, component, region, layer or section without departing from the teachings of the present disclosure.

Spatially relative terms, such as “lower”, “upper”, “top”, “bottom”, “left”, “right”, “inboard”, “outboard”, “forward”, “rear” and the like, may be used herein for ease of description to describe the relationship of one element or feature to another element(s) or feature(s) as illustrated in the drawing figures. It will be understood that spatially relative terms are intended to encompass different orientations of structures in use or operation, in addition to the orientation depicted in the drawing figures. For example, if a device in the drawing figures is turned over, elements described as “lower” relative to other elements or features would then be oriented “upper” relative the other elements or features. Thus, the exemplary term “lower” can encompass both an orientation of above and below. The device may be otherwise oriented (rotated 90 degrees or at other orientations) and the spatially relative descriptors used herein should be interpreted accordingly.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “including”, “comprises” and/or “comprising,” and variations thereof, for example, when used in this specification, specify the presence of stated features, integers, steps, operations, elements, and/or components, but do not preclude the presence or addition of one or more other features, integers, steps, operations, elements, components, and/or groups thereof.

Embodiments of the disclosure are described herein with reference to diagrams and/or cross-section illustrations, for example, that are schematic illustrations of idealized embodiments (and intermediate structures) of the disclosure. As such, variations from the shapes of the illustrations as a result, for example, of manufacturing techniques and/or tolerances, are to be expected. Thus, embodiments of the disclosure should not be construed as limited to the particular shapes of components illustrated herein but are to include deviations in shapes that result, for example, from manufacturing or fabrication.

Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Any reference in this specification to “one embodiment,” “an embodiment,” “example embodiment,” etc., means that a particular feature, structure, or characteristic described in connection with the embodiment is included in at least one embodiment of the disclosure. The appearances of such phrases in various places in the specification are not necessarily all referring to the same embodiment. Further, as otherwise noted herein, when a particular feature, structure, or characteristic is described in connection with any embodiment, it is submitted that it is within the purview of one skilled in the art to effect and/or use such feature, structure, or characteristic in connection with other ones of the embodiments.

Embodiments are also intended to include or otherwise cover methods of using and methods of manufacturing any or all of the elements disclosed above.

While the subject matter has been described in detail with reference to exemplary embodiments thereof, it will be apparent to one skilled in the art that various changes can be made, and equivalents employed, without departing from the scope of the disclosure. All related art references discussed herein are hereby incorporated by reference in their entirety. All documents referenced herein are hereby incorporated by reference in their entirety.

It will be understood by those persons skilled in the art that the present disclosure is susceptible to broad utility and application. Many embodiments and adaptations of the present disclosure other than those herein described, as well as many variations, modifications and equivalent arrangements, will be apparent from or reasonably suggested by the present disclosure and foregoing description thereof, without departing from the substance or scope of the disclosure.

Accordingly, while the present disclosure has been described here in detail in relation to its exemplary embodiments, it is to be understood that this disclosure is only illustrative and exemplary of the present disclosure and is made to provide an enabling disclosure of the disclosure. Accordingly, the foregoing disclosure is not intended to be construed or to limit the present disclosure or otherwise to exclude any other such embodiments, adaptations, variations, modifications and equivalent arrangements.

What is claimed is:

1. A tailgate security bracket assembly for mounting on a vehicle bed of a vehicle, comprising:
a retainment plate positioned in a first plane;
a lateral plate comprises a first connection edge and a second connection edge, wherein the lateral plate is connected to the retainment plate at the first connection edge, and the lateral plate extends inboard from the retainment plate;
a longitudinal attachment plate comprises a forward edge and a back edge, wherein the back edge of the longitudinal attachment plate is connected to the lateral plate at the second connection edge, wherein the longitudinal attachment plate is positioned in a second plane, and the second plane parallel to, and spaced inboard from, the first plane, and
one or more fastener assemblies enable to attach the tailgate security bracket assembly onto the vehicle, wherein at least one fastener assembly disposed at the longitudinal attachment plate.

2. The bracket assembly of claim 1, wherein the lateral plate is substantially at a 90 degree angle to the first plane and the second plane, so as to space the first plane from the second plane.

3. The bracket assembly of claim 1, wherein the retainment plate comprises a securement slot, and wherein the securement slot is configured to receive a support pin of the tailgate.

4. The bracket assembly of claim 3, wherein the securement slot is a curved edge segment.

5. The bracket assembly of claim 3, further comprises a retainment flange disposed at the retainment plate, wherein the retainment flange extends at least one of inboard and outboard from the securement slot, and wherein the retainment flange is provided to reinforce the securement slot.

6. The bracket assembly of claim 1, further comprises a transverse attachment plate connected to the forward edge of longitudinal attachment plate and extends parallel to the lateral plate, wherein the transverse attachment plate is provided to engage with the vehicle, so as to secure the tailgate security bracket onto the vehicle.

7. The bracket assembly of claim 1, wherein the lateral plate further comprises a lateral extension extending outboard from the first connection edge and lies in line with the lateral plate.

8. The bracket assembly of claim 1, wherein a top portion of the lateral plate, the longitudinal attachment plate and the transverse attachment plate together forms a substantially U-shaped configuration defining a first bracket, and
a bottom portion of the lateral plate, the longitudinal attachment plate and the transverse attachment plate together forms a substantially U-shaped configuration defining a second bracket, wherein the first bracket is fastened to the second bracket to form a single u-shaped configuration.

9. The bracket assembly of claim 1, wherein the retainment plate, the lateral plate and the longitudinal attachment plate integrally formed from sheet metal, wherein the first connection edge including a first bend in the sheet metal, and wherein the second connection edge including a second bend in the sheet metal.

10. The bracket assembly of claim 1, wherein the fastener assembly comprises a bolt and a nut, wherein the longitudinal attachment plate includes a hole, the bolt extends through the hole to attach to a rear structure of the vehicle bed and the nut is threaded onto the bolt.

11. The bracket assembly of claim 1, wherein at least one fastener assembly is disposed at the longitudinal attachment plate, wherein the fastener assembly comprises a stud fastened onto the longitudinal attachment plate so as to extend outboard from a surface of the longitudinal attachment plate, wherein the stud is configured to provide attachment to a rear structure of the vehicle bed.

12. The bracket assembly of claim 11, wherein the fastener assembly comprises a nut threaded onto the stud, and the fastener assembly is configured so as to sandwich the rear structure of the vehicle bed, between the longitudinal attachment plate and the nut.

13. The bracket assembly of claim 6, wherein the retainment plate, lateral plate, longitudinal attachment plate and transverse attachment plate forming a bracket, of the tailgate security bracket assembly, is integrally formed from an originally flat piece of sheet metal that is bent into shape of the bracket.

14. The bracket assembly of claim 6, wherein the retainment plate, lateral plate, longitudinal attachment plate and transverse attachment plate forming a bracket, is cast into the shape of the bracket.

15. The bracket assembly of claim 6, the transverse attachment plate is connected to the longitudinal attachment plate such that the transverse attachment plate is oriented at 90 degree angle to the longitudinal attachment plate, and configured to engage a rear post of the vehicle bed, of the vehicle.

16. The bracket assembly of claim 1, further comprises a plurality of fasteners configured to attach the longitudinal attachment plate to the vehicle bed.
